(19) United States
(12) Patent Application Publication
(10) Pub. No.: US 2007/0061395 A1
(43) Pub. Date: Mar. 15, 2007

(54) Gateway apparatus for information processing using mobile communication

(76) Inventors: Jun Gue Choi, Seoul (KR); Kam Youl Park, Seoul (KR)

Correspondence Address: THELEN REID & PRIEST, LLP, P. O. BOX 640640, SAN JOSE, CA, 95164-0640, US

(21) Appl. No.: 10/577,122

(22) PCT Filed: Oct. 28, 2004
(86) PCT No.: PCT/KR04/02744

§ 371 Date: Apr. 25, 2006

(30) Foreign Application Priority Data
Oct. 28, 2003 (KR) 10-2003-0075673

(51) Int. Cl. G06F 15/16

(52) U.S. Cl. 709/203

(57) ABSTRACT

A gateway apparatus for allowing a wireless multimedia terminal to access a server having DB storing various informations, to extract information from the server and display it on the wireless multimedia terminal, the apparatus comprising: a wireless multimedia communicater for receiving from the wireless multimedia terminal a server accessing menu message selected by a user, and for transmitting a message from the server to the wireless multimedia terminal; a received message interpreter for interpreting the significance of instructions out of the received message; a connection log generater for generating a connection log for the server in accordance with the interpreted information of the message; a statistics processer for performing statistical process for data queried from a stastics DB; a received message URL mapper for mapping a URL out of the received message from the wireless multimedia communicater; a URL caller for calling the mapped URL and accessing the server to request information; and a result data returner for returning the information received from the accessed server to the communicater for transmitting the information to the wireless multimedia terminal.

### TECHNICAL FIELD

The present invention relates to a gateway apparatus for allowing a wireless multimedia terminal to access a server having DB storing various informations, to extract information from the server and display it on the wireless multimedia terminal.

### BACKGROUND ART

Recently, according to the development of mobile communication technology and the popularization of mobile communication terminal (such as a cellular phone, PDA, etc.), a variety of information processing techniques based on the mobile communication terminal are being developed.

The mobile communication terminal, that now many people possess, is a useful means to be adapted to all sorts of information processing service, because it can perform bidirectional communication with a host, contrary to a conventional magnetic card or IC card, etc.

For example, by using mobile communication terminal, one can obtain various information from contents providers (CPs) through a wireless internet, as well as a variety of information processing (i.e., shopping, buying tickets, enquiring school record, applying lectures, requesting certificates from an administrative office, etc.). Recently, in addition, since wireless multimedia terminals (referred to as a multipack terminal) which support multimedia services have been commercially introduced. Therefore, the information processing services can be operated more easily.

As such, to operate the information processing services, there is needed a gateway apparatus for interfacing between a mobile communication system and a mobile communication terminal.

### DISCLOSURE OF INVENTION

It is an object of the present invention to provide a gateway apparatus that initiates the transmission of command signals data between a wireless multimedia terminal and a server.

To achieve the above object, there is provided a gateway apparatus comprising:

A gateway apparatus for allowing a wireless multimedia terminal to access a server having DB storing various informations, to extract information from the server and display it on the wireless multimedia terminal, the apparatus comprising: a wireless multimedia communicater for receiving from the wireless multimedia terminal a server accessing menu message selected by a user, and for transmitting a message from the server to the wireless multimedia terminal; a received message interpreter and a received message DB, the former interpreting the significance of instructions out of the received message, the latter storing the interpreted information of the message; a connection log generater for generating a connection log for the server in accordance with the interpreted information of the message; a statistics DB and a statistics processer, the former storing the connection log file generated in the connection log generater, the latter performing statistical process for data queried from the stastics DB; a received message URL mapper and a URL DB, the former mapping a URL out of the received message from the wireless multimedia communicater, the latter storing the mapped URL; a URL caller for calling the mapped URL and accessing the server to request information; and a result data returner and transmitted data DB, the former returning the information received from the accessed server to the communicater for transmitting the information to the wireless multimedia terminal, the latter storing the transmitted data.

### BRIEF DESCRIPTION OF THE DRAWINGS

The above and other objects, features, and advantages of the present invention will become more apparent from the following description when taken in conjunction with the accompanying drawings, in which:

FIG. 1 is a block diagram briefly showing the operation of the present invention,

FIG. 2 is a block diagram of a gateway apparatus of the present invention, and

FIGS. 3 to 6 are flowcharts showing the operation of each the block.

### PREFERRED EMBODIMENTS FOR CARRYING OUT THE INVENTION

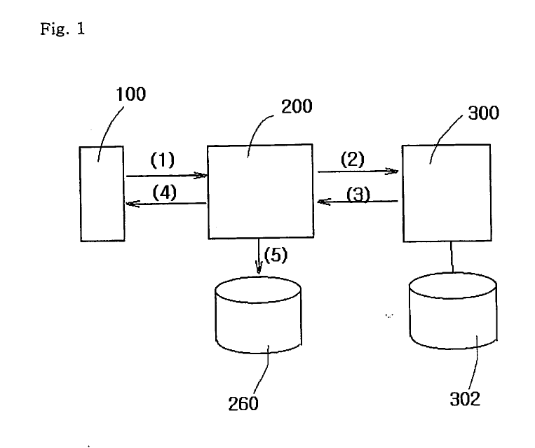

FIG. 1 is an operational schematic of a whole system using a gateway apparatus of the present invention: (1) If a menu item for accessing an information providing server 300 is selected by a wireless multimedia terminal 100, (2) a gateway 200 receives the menu item and calls a server having the pertinent URL, and, according to the menu item that a user selected, extracts data from a DB 302 of the server 300. (3) Then, the gateway apparatus 200 converts the format of a result message extracted from the server 300 into a format for wireless multimedia terminal, and transmits this format-converted signal to the wireless multimedia terminal 100. (4) The transmitted message is output from the wireless multimedia terminal 100. (5) In the meantime, the processed data is stored in a statistic DB 260 of the gateway 200 as statistical data for the gateway.

The operation of the gateway of the present invention will be briefly described. The gateway of the present invention plays a role of taking from a server the pertinent data requested through the wireless multimedia terminal by a user, converting the data from the server into the wireless multimedia format, and transmitting the converted data to the user. The overall data processing routine of the gateway is as follows: 1) Connecting to a user's personal wireless multimedia terminal through a socket or http protocol, 2) Receiving a service request from the user, i.e., recognizing OP code, 3) Making a connection statistics log, 4) Finding a real server and the pertinent URL for the requested service, 5) Calling the real server URL and extracting result value, 6) Converting data format for a wireless multimedia protocol, and 7) Transmitting the converted data to the user.

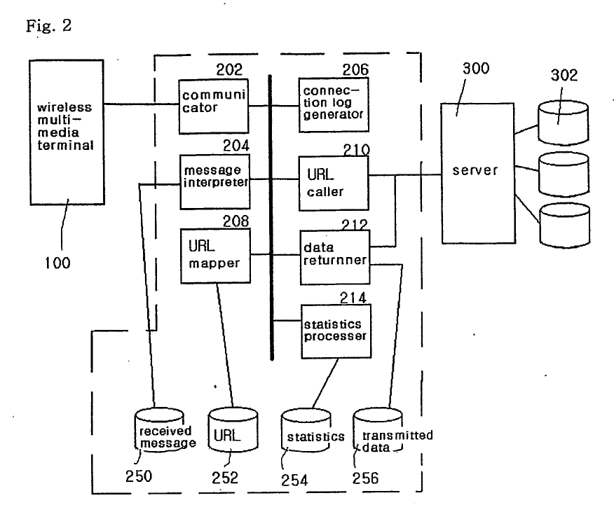

FIG. 2 shows an overall construction of the system of this invention. It can be noted that a gateway 200 is interposed between a wireless multimedia terminal 100 and a server 300. The server 300 includes a DB server 302 storing a variety of information. The server is constructed by utilizing wired/wireless websites based upon conventional platforms (e.g., Windows, UNIX, LINUX, etc.). The wireless multimedia terminal 100 includes menu function for accessing the server 300 and for selecting data to be taken from the server 300.

As shown in FIG. 2, the gateway 200 of the present invention comprises: a wireless multimedia communicater 202 for receiving from the wireless multimedia terminal 100 a server accessing menu message selected by a user, and for transmitting a message from the server 300 to the wireless multimedia terminal 100; a received message interpreter 204 and a received message DB 250, the former interpreting the significance of instructions out of the received message, the latter storing the interpreted information of the message; a connection log generater 206 for generating a connection log for the server in accordance with the interpreted information of the message; a statistics DB 254 and a statistics processer 214, the former storing the connection log file generated in the connection log generater 206, the latter performing statistical process for data queried from the stastics DB 254; a received message URL mapper 208 and a URL DB 252, the former mapping a URL out of the received message from the wireless multimedia communicater 202, the latter storing the mapped URL; a URL caller 210 for calling the mapped URL and accessing the server 300 to request information; and a result data returner 212 and transmitted data DB 256, the former returning the information received from the accessed server to the communicater 202 for transmitting the information to the wireless multimedia terminal 100, the latter storing the transmitted data.

The operation of the constituents will be discussed.

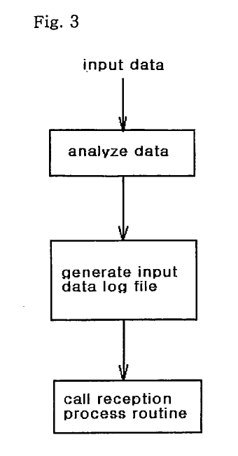

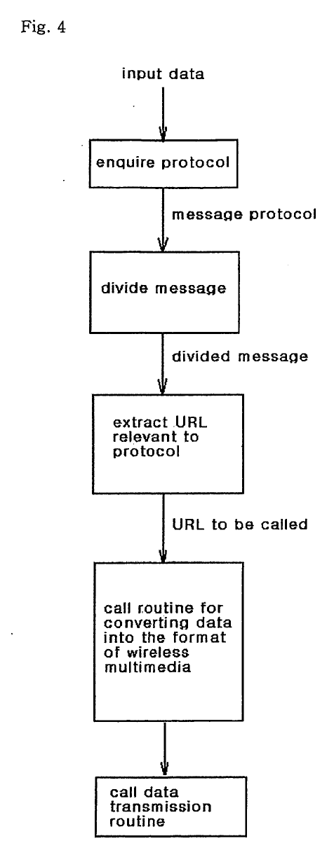

In FIG. 3, the received message interpreter 204 and the connection log generater 206 analyze the data input from the wireless multimedia terminal 100 (i.e., they divide the data based upon the predetermined protocol), generate and store an input data log file, and call a reception process routine. This reception process routine is detailed in FIG. 4.

In FIG. 4, a protocol of a message part of the analyzed input data is enquired and the data is divided according to the protocol. Then, URL relevant to the protocol is extracted from the divided message, and a routine for converting the data relating to the URL to be called into the format of wireless multimedia is called. The data converted by the routine is processed by a routine for data transmission and is transmitted.

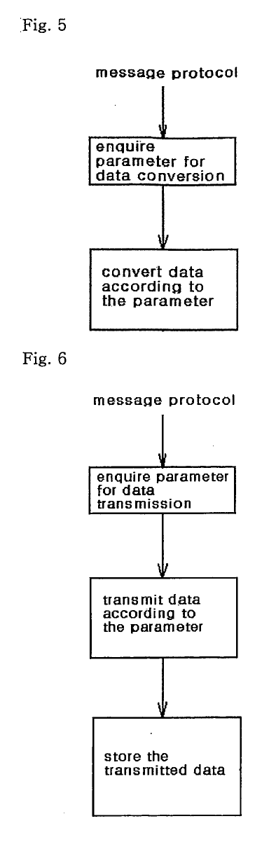

The routine for converting the data relating to the URL to be called into the format of wireless multimedia is detailed in FIG. 5. In FIG. 5, parameter (i.e., criteria) for data conversion is enquired out of the message protocol, and the data is converted according to the parameter.

The routine for data transmission is detailed in FIG. 6. Parameter for data transmission is enquired out of the message protocol, and the data converted in FIG. 5 is transmitted according to the parameter. The transmitted data is stored in DB 256 as a transmission log file.

While the invention has been shown and described with reference to certain embodiments to carry out this invention, it will be understood by those skilled in the art that various changes in form and details may be made therein without departing from the spirit and scope of the invention as defined by the appended claims.

The gateway of the present invention is applicable to a variety of usages. For example, when it is adapted to school affairs, users can enquire their school record or apply for lectures from a server established in their school by using a multimedia mobile phone (also called multipack terminal) through a wireless internet. In addition, if a particular sign, such as a barcode, is installed in a wireless multimedia terminal, users can be serviced entering a library, purchasing goods, lending books, etc. by using their phone instead of a conventional student identification card. The application of the present invention for the school affairs can be easily achieved by those who skilled in the art.

What is claimed is:

1. A gateway apparatus for allowing a wireless multimedia terminal to access a server having DB storing various informations, to extract information from the server and display it on the wireless multimedia terminal, the apparatus comprising:
A wireless multimedia communicater for receiving from the wireless multimedia terminal a server accessing menu message selected by a user, and for transmitting a message from the server to the wireless multimedia terminal;
a received message interpreter and a received message DB, the former interpreting the significance of instructions out of the received message, the latter storing the interpreted information of the message;
a connection log generater for generating a connection log for the server in accordance with the interpreted information of the message;
a statistics DB and a statistics processer, the former storing the connection log file generated in the connection log generater, the latter performing statistical process for data queried from the stastics DB;
a received message URL mapper and a URL DB, the former mapping a URL out of the received message from the wireless multimedia communicater, the latter storing the mapped URL;
a URL caller for calling the mapped URL and accessing the server to request information; and
a result data returner and transmitted data DB, the former returning the information received from the accessed server to the communicater for transmitting the information to the wireless multimedia terminal, the latter storing the transmitted data.

2. The apparatus of claim 1,
wherein the received message interpreter comprises means for analyzing input data from the wireless multimedia terminal based upon a predetermined protocol, and
wherein the connection log generater comprises means for generating and storing an input data log file, and calling a reception process routine.

3. The apparatus of claim 2, wherein the reception process routine comprises
means for enquiring a protocol of a message part of the analyzed input data,
means for dividing the input data according to the protocol,
means for extracting URL relevant to the protocol from the divided message,
means for converting the data relating to the URL to be called into a format of wireless multimedia, and
means for transmitting the data converted by the data converting means.

4. The apparatus of claim 3, wherein the means for data conversion comprises
means for enquiring parameter for data conversion out of the message protocol, and converting the data according to the parameter.

5. The apparatus of claim 3, wherein the means for data transmission comprises
means for enquiring parameter for data transmission out of the message protocol, and transmitting, according to the parameter, the data converted by the means for data conversion, and
means for storing the transmitted data in DB as a transmission log file.
